(19) United States
(12) Patent Application Publication
(10) Pub. No.: US 2008/0044506 A1
(43) Pub. Date: Feb. 21, 2008

(54) Tool for the production of fiber composite components

(75) Inventors: Pierre Zahlen, Stade (DE); Clemens Heim, Fredenbeck (DE); Jan Roettjer, Stade (DE); Axel Herrmann, Stade (DE)

Correspondence Address: WELSH & KATZ, LTD, 120 S RIVERSIDE PLAZA, 22ND FLOOR, CHICAGO, IL, 60606, US

(73) Assignee: AIRBUS DEUTSCHLAND GmbH, Hamburg (DE)

(21) Appl. No.: 11/893,028

(22) Filed: Aug. 14, 2007

Related U.S. Application Data
(60) Provisional application No. 60/838,232, filed on Aug. 17, 2006.

(30) Foreign Application Priority Data
Aug. 17, 2006 (DE) 10 2006 038 665.5
Mar. 23, 2007 (DE) 10 2007 013 987.1

(51) Int. Cl. B29C 70/36

(52) U.S. Cl. 425/130

(57) ABSTRACT

The present invention provides a tool for the production of fiber composite components. The tool has a surface for depositing semifinished fiber products on the surface, the surface having a number of openings for feeding a matrix to the deposited semifinished fiber products. It is consequently possible to dispense entirely or partly with a conventional flow promoter and possible to achieve a high quality of fiber composite component.

### CROSS-REFERENCE TO RELATED APPLICATIONS

This application claims the benefit of U.S. Provisional Application No. 60/838,232, filed Aug. 17, 2006, German Patent Application No. 10 2006 038 665.5 filed on Aug. 17, 2006 and German Patent Application No. 10 2007 013 987.1 filed on Mar. 23, 2007, the complete disclosures of which are herein incorporated by reference.

### FIELD OF THE INVENTION

The present invention relates to a tool for the production of fiber composite components.

### BACKGROUND OF THE INVENTION

Although it can be applied to any desired methods for producing fiber composite components, the present invention and the problems on which it is based are explained in more detail with reference to an infusion process.

In the production of a fiber composite component by the infusion process, various auxiliary materials are used, in particular a so-called flow promoter. A flow promoter is typically a knitted fabric with a high permeability. During the production of the fiber composite component, such a flow promoter lies over the surface area and/or under the dry laid fiber fabric and ensures that a matrix to be introduced into the dry laid fiber fabric distributes itself uniformly in the fabric. After the infusion, the component is then cured along with the flow promoter, which means that reuse of the flow promoter is not possible. This disadvantageously increases the production costs.

A further challenge with the use of flow promoters is caused by the fact that they leave impressions on the surface of the fiber composite component to be produced or themselves have irregularities which are correspondingly moulded into the fiber composite component.

Furthermore, conventional flow promoters have only inadequate production tolerances, which in turn have adverse effects for example on the planarity of the component.

Furthermore, the formation of folds in the flow promoter as a result of poor draping or slipping may lead to undulations in the fiber composite component. In addition, correct draping of the flow promoter is often very difficult or impossible for fiber composite components with complex contours.

### SUMMARY OF THE INVENTION

In view of the foregoing, it is therefore an object of the present invention to provide a tool which makes it possible to produce a fiber composite component with high quality more easily and at lower cost.

This object is achieved according to the invention by a tool with the features of Patent claim 1.

Accordingly, a tool for the production of fiber composite components is provided. The tool has a surface for depositing (i.e. placing) semifinished fiber products, the surface having a number of openings for feeding a matrix to the deposited semifinished fiber products.

The idea on which the invention is based is to dispense entirely or partly with the conventional flow promoter and instead to feed the matrix, for example a resin, through a number of openings in the surface to semifinished fiber products deposited on it. Consequently, the semifinished fiber products can be uniformly supplied with the matrix substantially over their entire surface area, which leads to a uniform distribution of the matrix in the semifinished fiber products. A high quality of the fiber composite component can be achieved in this way.

Furthermore, there are no material costs for flow promoters. In addition, fiber composite components with very exact tolerances and smooth surfaces can be easily produced by means of the invention.

Advantageous refinements and improvements of the invention can be found in the subclaims.

According to a further preferred development of the invention, the openings are formed as grooves in the surface of the tool. A matrix stream flowing in the respective groove is in contact over its entire length with semifinished fiber products on the surface and can consequently be taken up uniformly by the said products.

Alternatively or in addition, the openings may of course also be formed merely as substantially vertical bores that are distributed over the surface and are connected to resin supply channels in a table of the tool.

According to a further preferred refinement of the invention, a density per unit area and/or a width and/or a depth and/or an arrangement/orientation and/or a routing and/or a cross-sectional form of the grooves is adapted to predetermined impregnating properties of the semifinished fiber products.

“Impregnating properties” refer to all the features of the semifinished products that have an influence on the distribution or take-up of matrix in the latter, for example the thickness of the semifinished fiber products, the thickness of individual filaments or the orientation of the filaments.

“Density per unit area” is understood in the present case as preferably meaning the proportion of the surface, in a plan view of the tool, that is assigned to the grooves in relation to the proportion of the surface of the tool that is delimited by the grooves.

In particular, the throughput of the matrix and/or the time during which the matrix is in contact with the semifinished fiber products can be controlled by the density per unit area and/or width and/or depth and/or arrangement/orientation and/or routing and/or cross-sectional form. The “throughput” indicates in the present case the amount of matrix that flows per unit of time through a region.

In a broad approximation, the throughput can be assumed to be proportional to the cross-sectional area of the grooves. Deviations from the approximation are caused by the resin sticking to the surface and by the groove geometry.

According to a further preferred developed of the invention, the grooves are provided with a first density per unit area in a first region of the surface and with a second density per unit area in a second region of the surface. The second density per unit area may be different from the first density per unit area. Consequently, a different throughput of the matrix can be set in the first region than in the second region. The amounts of matrix required for impregnation differ in different regions, for example as a result of the thickness to be formed of the fiber composite component. This requirement can consequently be satisfied.

According to a further preferred embodiment of the invention, the grooves are inclined by an angle in relation to a line joining an inlet and an outlet in a third region of the surface, the angle lying in a range from 0° to 90°. The mean flow direction of the matrix runs substantially from the inlet to the outlet. In the third region, the resin moves obliquely in relation to the mean flow direction and consequently stays longer in the third region. A greater amount of the matrix consequently has the possibility of flowing into the semifinished product in the third region. This is of advantage in particular whenever the semifinished fiber products are thick or have a low permeability in this region.

In a preferred development, the grooves have a first width in a fourth region of the surface and a second width in a fifth region of the surface, the first width being greater than the second width. Consequently, a higher throughput of the matrix can be set in the fourth region than in the fifth region in the case where the fourth and fifth regions are supplied with the matrix separately. If, however, the matrix flows from the fourth region into the fifth region, it has a lower flow rate in the fourth region than in the fifth region. Consequently, the resin stays longer in the fourth region and can, for example, be taken up better there by the semifinished fiber product.

The width of the grooves preferably varies in the range between 0.1 mm and 4 mm.

In a further preferred refinement of the invention, an auxiliary material is arranged on the surface, the auxiliary material being permeable to the matrix. The auxiliary material may in this case take the form of a peel ply or a release film. This advantageously allows detachment of the fiber composite component from the surface of the tool or from the vacuum film.

In a further preferred development of the invention, the tool has an inlet for feeding in the matrix and an outlet for carrying away the matrix, the inlet and the outlet being arranged in different planes, in particular parallel to the surface. The planes in this case lie with preference on opposite sides of the semifinished fiber products. This can achieve the effect that the matrix has to flow through the semifinished fiber products in order to reach the outlet from the inlet. This may, for example, lead to better impregnation within a shorter time.

### BRIEF DESCRIPTION OF THE DRAWINGS

FIG. 1A shows a view of a section through a tool with a placed-in semifinished fiber product according to an exemplary embodiment of the invention;

FIG. 1B shows a view of a section through a tool with a placed-in semifinished fiber product according to a further exemplary embodiment of the invention;

FIG. 2 shows a plan view of a tool according to yet a further exemplary embodiment of the invention;

FIG. 3 shows a view of a section along the sectional line E-E from FIG. 2;

FIG. 4 shows a plan view of a tool according to yet a further exemplary embodiment of the invention;

FIG. 5 shows a plan view of a tool according to get a further exemplary embodiment of the invention;

FIG. 6 shows a plan view of a tool according to yet a further exemplary embodiment of the invention;

FIG. 7 shows a plan view of a tool according to yet a further exemplary embodiment of the invention; and

FIG. 8 shows a view of a section through a tool for an injection process according to yet a further exemplary embodiment of the invention.

### In the figures, the same reference numerals designate components that are the same or functionally the same, unless otherwise indicated.

### DETAILED DESCRIPTION OF THE INVENTION

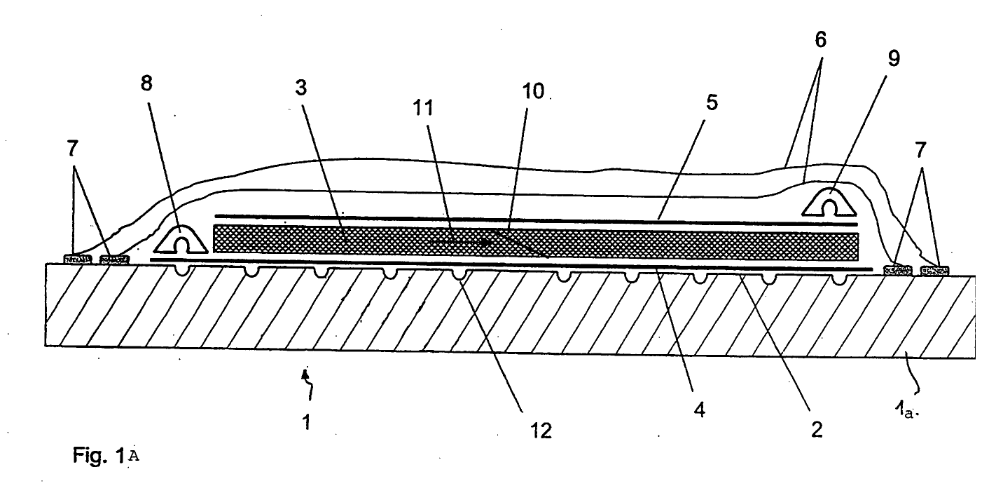

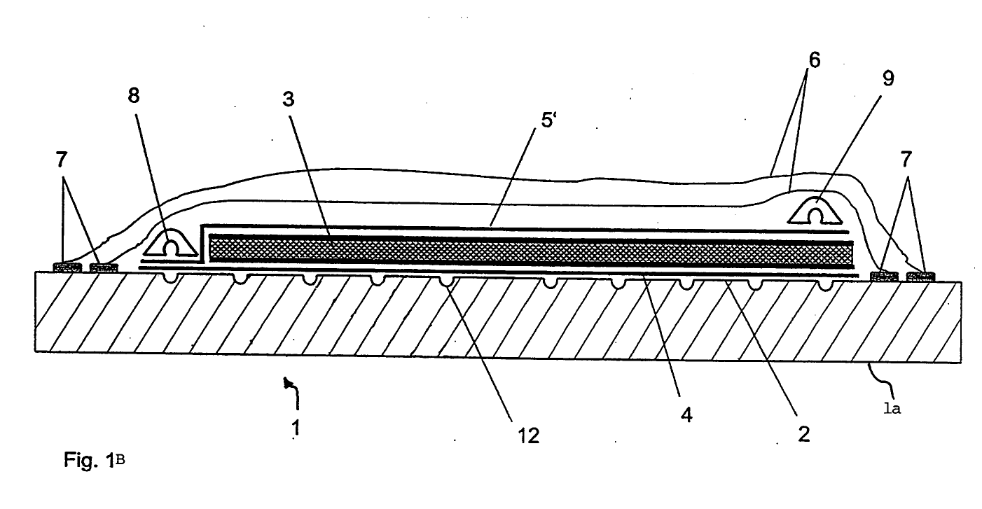

FIG. 1A shows a view of a section through a tool 1 with a placed-in semifinished fiber product 3 according to an exemplary embodiment of the invention.

The tool 1 has a table 1a with a surface 2, the form of which defines the form of the components to be produced. The table 1a preferably consists of metal, but may also consist of plastics, ceramics or other suitable materials.

On the surface 2, the semifinished fiber product 3 is arranged. The semifinished fiber product 3 may be, for example, a laid, woven or knitted fabric, a nonwoven fabric, loose fibers or a sandwich-like structure. The thickness of the semifinished fiber product 3 may also vary over the surface 2.

A peel ply and/or a release film 4 is/are typically arranged between the surface 2 and the semifinished fiber product 3. In the same way, such a release film and/or peel ply 5 may also be arranged on the semifinished fiber product 3.

The entire construction is packed in an airtight manner by means of a vacuum film 6 and sealing strips 7. It may prove to be expedient to use a double-walled vacuum film 6, as indicated in FIG. 1. Also possible in principle are other types of vacuum bagging that are necessary for different processes (for example introducing membranes in the case of vacuum assisted processing (VAP) or inlet and outlet are identical as in the case of single line injection (SLI)). The air under the vacuum film 6 is extracted by way of pumping connections 9.

An inlet 8 is connected to a reservoir (not represented) for resin. The resin is sucked into the bagging by the pressure gradient forming. The resin flows along the surface 2 of the tool 1 and through the semifinished fiber product 3. It is of particular importance here that the semifinished fiber product 3 is uniformly impregnated with the resin. Excess resin is carried away at an outlet 9.

The inlet 8 and/or the outlet 9 may be integrated in the surface 2 of the tool 1. On the other hand, it is similarly possible to provide them in the conventional way as tubular or punctiform feeds which are packed underneath the vacuum film 6. The inlet 8 and the outlet 9 are preferably in different planes, in particular on different sides of the semifinished fiber product 3.

Grooves 12 (for the sake of overall clarity, only one of the grooves is provided with a reference numeral) in the surface 2 connect the inlet 8 to the outlet 9. The resin can consequently distribute itself uniformly over the surface 2 in the grooves 12.

The groove cross section is preferably half-round, but may also be of any other desired form. The width lies with preference in the range from 0.1 mm to 4 mm. The depth may be of the same order of magnitude. The groove cross section can also be used at the same time to set the throughput of resin. Two grooves may also differ over part of their length or over their entire length in cross section, geometry, width and/or arrangement.

The flow of the resin is schematically indicated by the flow front 10. The flow front 10 has an inclination with respect to the vertical. This is caused by the different flow rate of the resin in the grooves 12 and the semifinished fiber product 3. The flow rate in the grooves 12 should preferably be adapted to the flow rate in the semifinished fiber product 3.

With respect to FIG. 1B, only the differences in comparison with the construction from FIG. 1A are to be discussed.

On the side facing away from the tool, a conventional flow promoter 5′ has been applied to the semifinished fiber product 3, which has for example a sandwich construction. This flow promoter 5′ is connected to the inlet 8 and the outlet 9. As a result, faster impregnation of the semifinished fiber product 3 with resin can be achieved in comparison with the exemplary embodiment according to FIG. 1A. However, the side of the semifinished fiber product 3 facing the surface 2 continues as before to be subjected to resin without a flow promoter.

Thereafter, various embodiments of the tool 1 are respectively shown in a plan view or sectional view. These can be combined with one another in various ways.

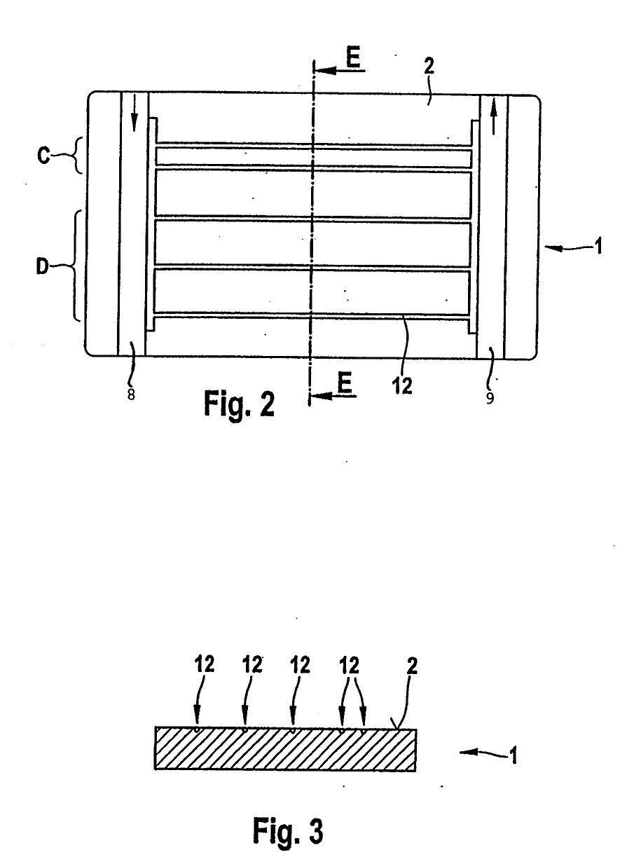

FIG. 2 shows parallel running grooves 12, which connect an inlet 8 to an outlet 9. The grooves 12 are upwardly open, as shown in the cross section along the sectional line E-E in FIG. 3.

In FIG. 2, the density per unit area of the grooves 12 is, for example, greater in the region C than in the region D. As a result, the greater throughput of resin is achieved in the region C than in the region D. Moreover, more uniform wetting of the surface 2 can be achieved.

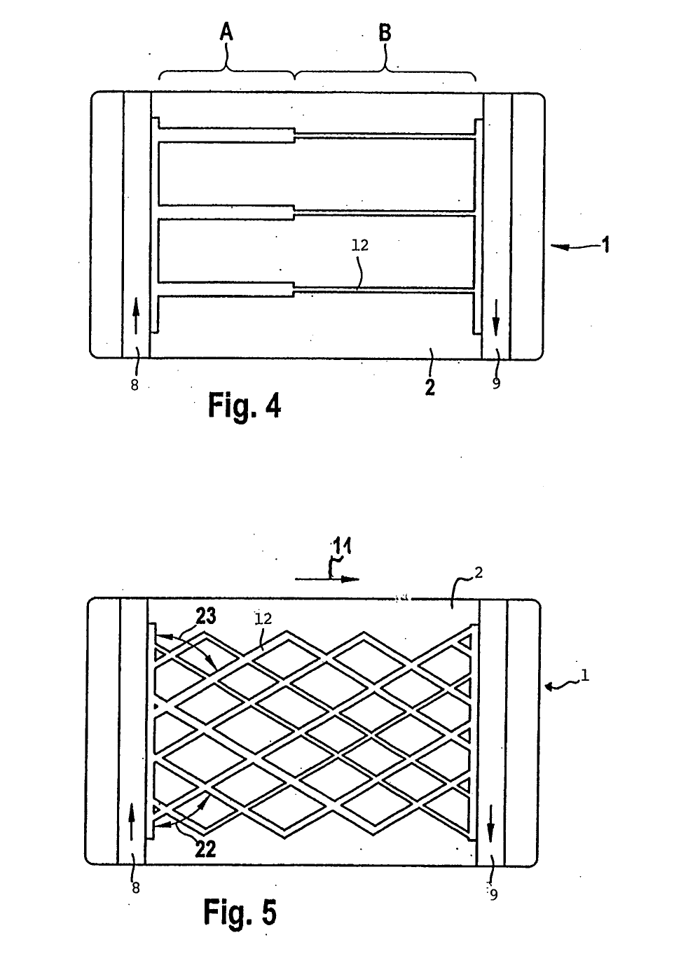

FIG. 4 shows parallel running grooves 12, which connect an inlet 8 to an outlet 9. In a region A near the inlet 8, the grooves 12 are wider than in a region B near the outlet 9. Consequently, more resin can be taken up by a placed-in semifinished fiber product in the region A than in the region B, in particular since the resin flows more slowly in the region A.

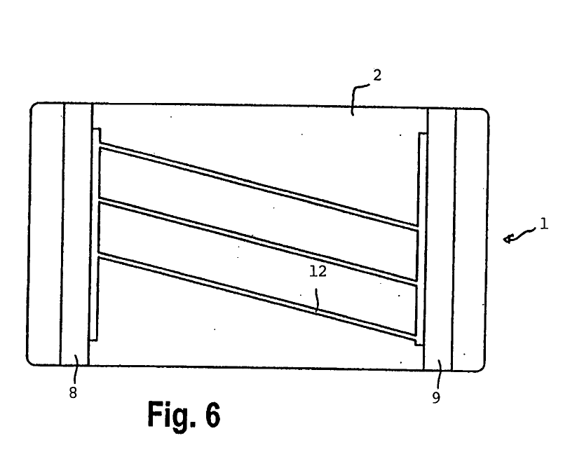

FIG. 5 shows an inlet 8 and an outlet 9. A network of crossing grooves 12 connects the inlet 8 and the outlet 9. The mean flow direction is substantially from the inlet 8 to the outlet 9, as indicated by the arrow 11.

The grooves 12 have an inclination or an angle 22, 23 with respect to the mean flow direction 11. The resin consequently does not flow from the inlet 8 to the outlet 9 by a direct path. The lengthening of the path has the effect that the resin stays longer in contact with placed-in semifinished fiber products.

The angles 22, 23 may lie in the range from 0° to 90°, preferably 40° to 50°.

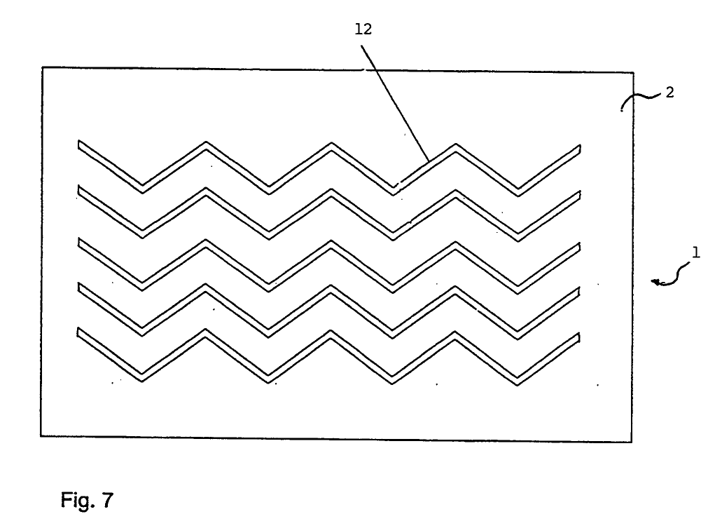

In a further exemplary embodiment of the tool 1 according to the invention, as shown in FIG. 6, parallel grooves 12 may connect an inlet 8 to an outlet 9. The grooves 12 may in turn be inclined with respect to the mean flow direction.

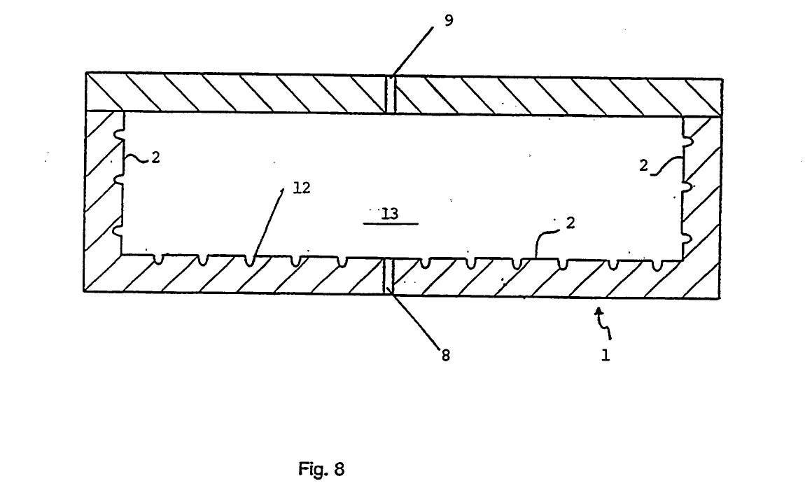

Grooves 12 in FIG. 7 are arranged in an approximately zigzag form and thereby likewise inclined in relation to the mean flow direction.

FIG. 8 shows a section through a tool 1 for an injection process according to yet a further exemplary embodiment of the invention. The tool 1 is in this case formed such that it can be closed in a pressure-tight manner. Resin is fed in and carried away by way of an inlet 8 and outlet 9, respectively. The distribution of the resin takes place by way of grooves 12 in the surface 2 of the tool 1. Semifinished fiber products arranged in the cavity 13 can consequently be impregnated uniformly.

After the production of a fiber composite component, the tool 1 can in principle, if required, be freed of any remains of resin or cleaned. As a result, repeated use of the tool 1 is ensured.

In the figures, the surface 2 is represented in a planar form. However, this is not to be considered as restrictive. The surface 2 may have any desired curved forms. The grooves, however, continue to run in the surface.

Although the present invention has been described here on the basis of preferred exemplary embodiments, it is not restricted to these but can be modified in various ways.

The present invention provides a tool for the production of fiber composite components. The tool has a surface for depositing semifinished fiber products on the surface, the surface having a number of openings for feeding a matrix to the deposited semifinished fiber products. It is consequently possible to dispense entirely or partly with a conventional flow promoter and possible to achieve a high quality of fiber composite component.

What is claimed is:

1. A tool for the production-of fiber composite components, the tool comprising a surface for depositing semifinished fiber products thereon, the surface having a number of openings for feeding a matrix to the deposited semifinished fiber products.

2. The tool according to claim 1, wherein the openings are constituted by grooves in the surface.

3. The tool according to claim 2, wherein at least one of a density per unit area, a width, a depth, an arrangement, an orientation, a routing and a cross-sectional form of the grooves is adapted to a predetermined impregnating property of the semifinished fiber products.

4. The tool according to claim 2, wherein the grooves are provided with a first density per unit area in a first region of the surface and the grooves are provided with a second density per unit area in a second region of the surface.

5. The tool according to claim 1, wherein the grooves are inclined by an angle in relation to a line joining an inlet and an outlet in a third region of the surface, the angle being in a range from 0° to 90°0.

6. The tool according to claim 2, wherein the grooves have a first width in a fourth region of the surface and the grooves have a second width in a fifth region of the surface, the first width being greater than the second width.

7. The tool according to claim 2, wherein the width of the grooves lies in the range from 0.1 mm to 4 mm.

8. The tool according to claim 1, wherein an auxiliary material is arranged on the surface, the auxiliary material being permeable to the matrix.

9. The tool according to claim 1, wherein the tool has an inlet for feeding in the matrix and an outlet for carrying away the matrix, the inlet and the outlet being arranged in different planes.
